(19) United States
(12) Patent Application Publication
(10) Pub. No.: US 2017/0125882 A1
(43) Pub. Date: May 4, 2017

(54) WIRELESSLY PROGRAMMABLE ELECTRONIC CONTROL GEAR

(71) Applicant: OSRAM GmbH, Munich (DE)

(72) Inventors: Thomas Pollischansky, Munich (DE); Giancarlo Marcolin, Treviso (IT); Raffaele Piva, Munich (DE)

(21) Appl. No.: 15/289,218

(22) Filed: Oct. 10, 2016

(30) Foreign Application Priority Data
Oct. 30, 2015 (DE) 10 2015 221 281.5

(51) Int. Cl. H01Q 1/22; H05B 41/36; H05B 33/08

(52) U.S. Cl. CPC H01Q 1/2283; H05B 33/0842; H05B 41/36

(57) ABSTRACT

Various embodiments provide a wirelessly programmable electronic control gear, which may include an essentially enclosed metal or metallized housing. The housing is a punched and curved sheet-metal housing. The wirelessly programmable electronic control gear may further include a circuit board with an antenna component fitted thereon to receive wireless programming signals, and an area in the metal or metallized housing which has at least one longitudinal recess. The at least one recess is located close to the antenna. The orientation of the longitudinal recess is designed as essentially parallel to magnetic field lines of the antenna.

### CROSS-REFERENCE TO RELATED APPLICATION

This application claims priority to German Patent Application Serial No. 10 2015 221 281.5, which was filed Oct. 30, 2015, and is incorporated herein by reference in its entirety.

### TECHNICAL FIELD

Various embodiments relate to a wirelessly programmable electronic control gear, e.g. for light-emitting diode modules or discharge lamps.

### BACKGROUND

Various embodiments are based on a wirelessly programmable electronic control gear. Electronic control gears are increasingly designed as digital control gears with a microcontroller or microprocessor in order to be able to perform a variety of control and adjustment tasks. For cost-saving reasons, “intelligent” control gears which can operate lamps and modules that differ in size and power have been available on the market for a number of years. As a result, substantial logistics costs are saved, and the devices can be manufactured in larger quantities. These devices identify the connected lamps or modules autonomously and set the correct voltage and the correct current for the lamp or module. However, additional hardware is required on the module and in the control gear in order to be able to identify the module correctly. An “intelligence” which identifies the additional components on the module and sets the operating parameters accordingly must be installed in the control gear. However, this “intelligence” is relatively complex to implement and significantly increases the cost of the control gears.

There has therefore been a trend for some time towards multifunctional devices which are parameterizable. These devices can also operate many different lamp or module types, but are not capable of identifying the correct type autonomously. This offers the effect that these control gears can be manufactured in large quantities and significantly less logistics outlay is required, since one device can be used for many different lamp or module types. These devices are parameterizable accordingly, they can be parameterized before or after installation in a specific light for the lamp types or (LED) module types that are used, so that the latter can be operated with the correct current and the correct voltage. This saves on expensive intelligence, so that these devices have a very good cost-benefit ratio.

The parameterization can be performed in a line-connected or wireless manner. More recently, wireless devices that can be parameterized with NFC technology have become increasingly prevalent. This technology uses high-frequency electromagnetic waves as the transmission medium. In the case of protection class 1 devices, the problem now exists that the electromagnetic waves cannot penetrate the device due to the metal housing.

FIG. 1 shows a view of the connection block of a conventional wirelessly programmable electronic control gear. In a conventional solution to the problem, an antenna is disposed outside the housing alongside the terminal block, so that the wireless programming signals can be received. This solution circumvents the problem of the metal housing 11, since the antenna 3 is disposed at this position outside the housing together with the terminals on a circuit board 12. A disadvantage here is that valuable space for the terminals is used and the layout of the circuit board 12 becomes unnecessarily complicated, as there is little space on the circuit board surface at this position, since prescribed air gaps and leakage paths must be maintained. Furthermore, the processing logic is disposed further inside the device, resulting in long conductor paths to the antenna 3 and the programming is quite susceptible to interference due to these long conductor paths.

### SUMMARY

Various embodiments provide a wirelessly programmable electronic control gear, which may include an essentially enclosed metal or metallized housing. The housing is a punched and curved sheet-metal housing. The wirelessly programmable electronic control gear may further include a circuit board with an antenna component fitted thereon to receive wireless programming signals, and an area in the metal or metallized housing which has at least one longitudinal recess. The at least one recess is located close to the antenna. The orientation of the longitudinal recess is designed as essentially parallel to magnetic field lines of the antenna.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a view of the connection block of a conventional wirelessly programmable electronic control gear;

FIG. 2 shows a side view of a sheet-metal housing part of a wirelessly programmable control gear according to various embodiments with a plurality of longitudinal recesses;

FIG. 3 shows a detailed view of a control gear according to various embodiments from outside, wherein the antenna component is visible behind the longitudinal recesses;

FIG. 4 shows a detailed view of the control gear from FIG. 3 from inside with a circuit board associated with the control gear and the antenna component in front of the longitudinal recesses in the sheet metal of the housing part; and

FIG. 5 shows a view of the control gear according to various embodiments, which illustrates the wireless programming of the control gear, with a programming device, the antenna of which is held close to the longitudinal recesses in the housing of the control gear in order to program the control gear.

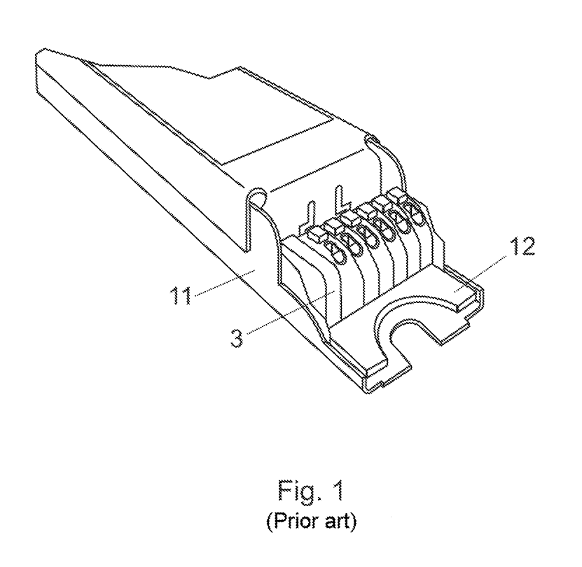

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

The embodiments shown in the following figures relate to wirelessly programmable electronic control gears with a punched and curved metal housing. Different wireless RFID technologies such as NFC (Near Field Communication) according to the ISO (International Standardization Organization) 13157/16353 or ISO14443 standard or RFID (Radio Frequency Identification) in the LF (Low frequency) or HF (High frequency) range can be used here. The embodiments merely need to be adapted to the frequency range that is used. The frequency range may typically be in the range from 100 kHz to 100 MHz.

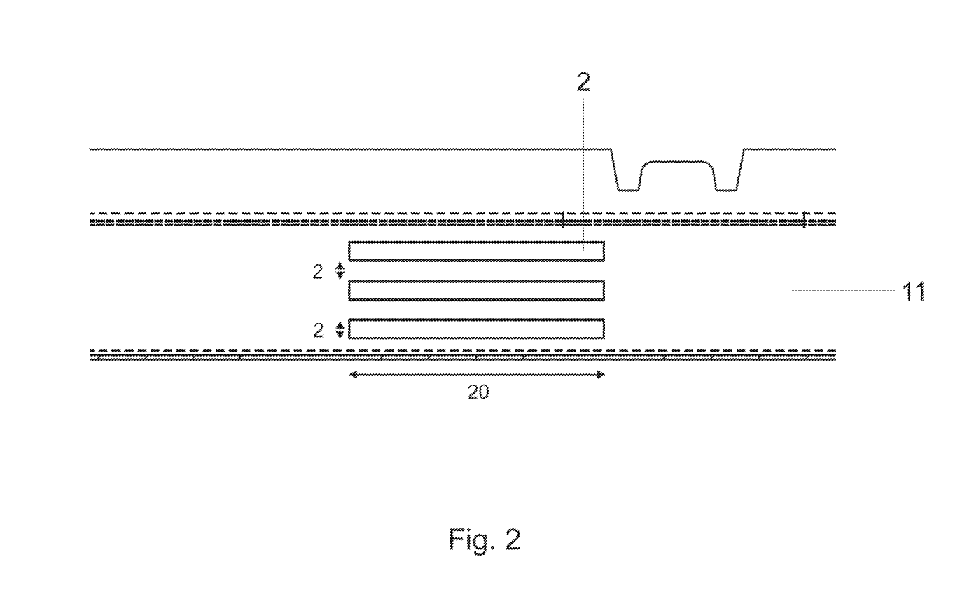

FIG. 2 shows a side view of a sheet-metal housing part 11 of a wirelessly programmable control gear 1 with three longitudinal recesses 2. The length and width of the recesses 2 are adapted to the antenna component 3 inside the housing. The length of the recesses should be one to three times the length of the antenna component 3 so that the magnetic fields of the programming device can flow completely axially through said antenna component. The length is typically 10 mm to 40 mm. The attenuation of electromagnetic waves in the sheet metal is based on the fact that they induce eddy currents. The recesses prevent the formation in the housing of eddy currents that would flow orthogonally in relation to said recesses. The attenuating effect on the electromagnetic fields of the RFID signals is thereby reduced. They may in part penetrate the metal housing and be received by the antenna component 3.

The maximum width of the recesses is limited in that, in the case of dangerous voltages of more than 48 V inside the housing, persons must be protected against contact. They must not, for example, be able to touch live parts on the inside with a finger. This can be verified in accordance with IEC (International Electrotechnical Commission) 61347-1. A maximum width of the recesses of 3 mm is therefore appropriate. An additional plastic wall or plastic film between the housing and the antenna component 3 can additionally ensure contact safety and insulation.

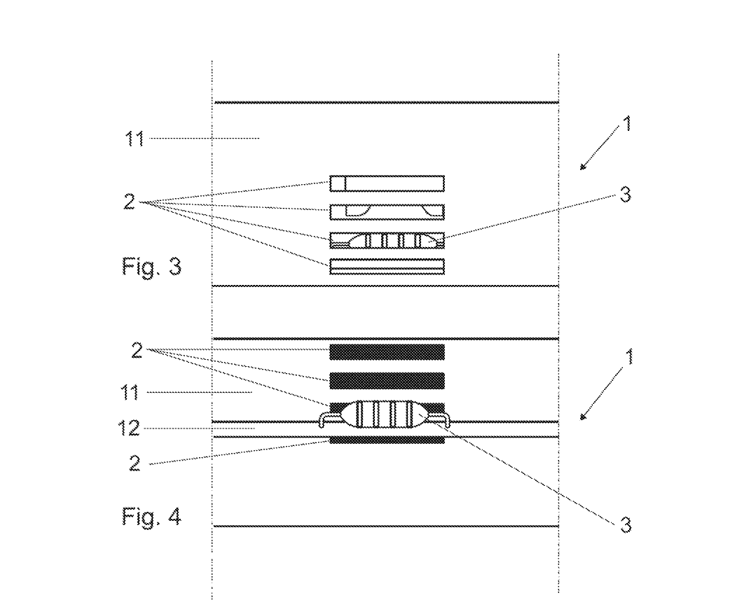

FIG. 3 shows a detailed view of a wirelessly programmable control gear 1 from outside. The antenna component 3 is visible behind the four longitudinal recesses 2. In order to make use of the magnetic coupling, the antenna 41 of the programming device 4 and the antenna component 3 may be disposed as close as possible to one another. The antenna component 3 is therefore disposed close to the recesses 2. The term “close” means here that the antenna component 3 is distanced by no more than half the length of a recess 2 from said recess. If the recesses are therefore, for example, 20 mm long, the antenna component is disposed at a maximum distance of 10 mm from them. A good magnetic coupling is thus ensured, insofar as the antenna 41 of a programming device 4 with which the electronic control gear 1 according to various embodiments is programmed is disposed at a distance of no more than typically 50 mm from the recesses 2 when the programming takes place.

FIG. 4 shows a detailed view of the wirelessly programmable control gear 1 from FIG. 3 from inside with a circuit board 12 associated with the control gear and with the antenna component 3 in front of the longitudinal recesses 2 in the sheet metal of the housing part 11. In various embodiments, the housing is a longitudinal metal housing of the type frequently used for electronic control gears. It can be clearly seen that the antenna component 3 is disposed in the longitudinal direction of the housing, level with the recesses, in order to optimize the coupling. Here, the antenna component 3 is a simple axial choke which is particularly economical and can be simply equipped. These chokes are also referred to as bobbin core chokes. An axial choke of this type is available at low cost as a standard component. The axial choke 3 is disposed on the edge of the circuit board 12 which lies closest to the recess. Is thus disposed at a distance of a few millimetres lengthways level with the recesses, resulting in an optimum coupling.

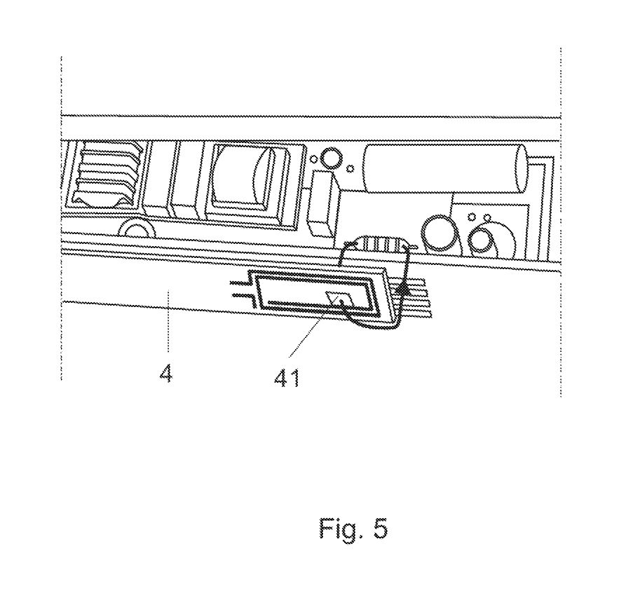

FIG. 5 shows a view of the control gear 1 to illustrate the wireless programming. The antenna 41 of a programming device 4 is held close to the longitudinal recesses 3 in the housing of the control gear 1 in order to program the control gear 1. The antenna 41 is typically implemented as an induction loop on the circuit board of the programming device. It can be clearly seen that the antenna 41 of the programming device 4 is located very close to the recesses 2 in the housing and therefore very close to the antenna component 3 of the control gear. A good coupling between the two antennas is thus achieved. The conductor paths of the induction loop 41 must be positioned orthogonally in front of the recesses 2. The magnetic field of the induction coil can thus flow axially through the antenna component 3. The connection can be regarded in simplified terms as a transformer without an iron core in which the coupling is established via the air gap through the recesses 2.

Various embodiments indicate a wirelessly programmable electronic control gear which does not have the aforementioned disadvantages and therefore provides enough space for a terminal block with a simplified circuit board layout.

Various embodiments provide a wirelessly programmable electronic control gear, having an essentially enclosed metal or metallized housing, a circuit board with an antenna component fitted thereon to receive wireless programming signals, an area in the metal or metallized housing which has at least one longitudinal recess. The at least one recess is located close to the antenna. The orientation of the longitudinal recess is designed as essentially parallel to magnetic field lines of the antenna.

With the solution according to various embodiments, on the one hand, the limit values relating to electromagnetic compatibility are still maintained, and a facility is additionally provided for wirelessly programming the electronic control gear, e.g. for parameterizing different operating currents for different LED modules.

An essentially enclosed housing is understood below to mean a housing of which the openings are dimensioned so that it attenuates the electromagnetic radiation emitted by the circuit arrangement located in the housing in such a way that the relevant standards relating to electromagnetic compatibility are observed. This means that the housing may in fact have openings, but they are sufficiently small in order to sufficiently attenuate the resulting electromagnetic radiation.

It will furthermore be explained below what “orientation of the longitudinal recess essentially parallel to magnetic field lines of the antenna” is to be understood to mean. In various embodiments, the antenna is an axial choke. The magnetic field lines around this axial choke have an approximately oval shape, having a clear directional inclination along the longitudinal axis of the oval. This is shown, for example, in a Wikipedia graphic (https://de.wikipedia.org/wiki/Magnetischer_Fluss#/media/File:Magnetische_Spannung_in_Spule.svg), consulted on 20 Oct. 2015. The longitudinal recess similarly now has a “tendency” in the longitudinal direction. As will be shown below, the length of the recess is significantly greater than its width. These two directions should have the smallest possible angle in relation to one another in order to achieve a good result.

In various embodiments, the at least one longitudinal recess has a length of 10 mm to 40 mm. A good permeability for the programming signals is thus ensured, with a continued effective screening in terms of electromagnetic compatibility.

In various embodiments, the at least one longitudinal recess has a width of between 1 mm and 3 mm. This measure guarantees the prescribed finger safety required by various standards such as e.g. the standard IEC 61347-1.

According to various embodiments, the control gear is configured to be programmed by means of the ISO 13157/16353 standard. This standard describes “near field communication”, a radio standard for small distances. The programmable control gear can be particularly simply parameterized by means of this standard.

According to various embodiments, the control gear is configured to be programmed by the IEEE 802.15.1 standard. This standard similarly entails a near-field standard, generally referred to by the name of “Bluetooth”. An effective and safe programming of the control gear can be performed with this standard also.

In various embodiments, a plastic film or plastic wall is located between the recesses and the antenna. This establishes a further contact safety, so that no dangerous situations can arise even with a wire or nail, and the overall safety of the control gear is increased.

In various embodiments, the antenna component is an axial choke. Axial chokes are cheaply and readily available. Chokes of this type are also easy to equip, so that they represent a particularly cost-effective solution for an antenna component. The choke may have an inductance of 2 μH to 6 μH. An optimum transmission of the programming data is guaranteed with this dimensioning.

In various embodiments, the housing is a punched and curved sheet-metal housing. Housings of this type are widespread in electronic ballast units and in lighting technology, are very safe in terms of touchability and have a very good electromagnetic compatibility. Particularly effective protection against electric shock may be ensured by the earthing of the electrically conducting housing. The recesses according to the invention can be inserted into a housing of this type in a very simple and low-cost manner through punching.

### REFERENCE NUMBER LIST

1 Programmable control gear
2 Longitudinal recesses
3 Antenna component in the embodiment as an axial choke
4 Programming device
11 Housing part
12 Circuit board
41 Antenna of the programming device

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A wirelessly programmable electronic control gear, comprising:
an essentially enclosed metal or metallized housing, wherein the housing is a punched and curved sheet-metal housing;
a circuit board with an antenna component fitted thereon to receive wireless programming signals;
an area in the metal or metallized housing which has at least one longitudinal recess;
wherein the at least one recess is located close to the antenna; and
wherein the orientation of the longitudinal recess is designed as essentially parallel to magnetic field lines of the antenna.

2. The control gear of claim 1,
wherein the at least one longitudinal recess has a length of 10 mm to 40 mm.

3. The control gear of claim 1,
wherein the at least one longitudinal recess has a width of between 1 mm and 3 mm.

4. The control gear of claim 1,
wherein the control gear is configured to be programmed by the ISO 13157/16353 standard.

5. The control gear of claim 1,
wherein the control gear is configured to be programmed by the IEEE 802.15.1 standard.

6. The control gear of claim 1,
wherein a plastic film or plastic wall is located between the recesses and the antenna.

7. The control gear of claim 1,
wherein the antenna component is an axial choke.

8. The control gear of claim 1,
wherein the choke has an inductance of 2 μH to 6 μH.

9. A wirelessly programmable electronic control gear, comprising:
an essentially enclosed metal or metallized housing;
a circuit board with an axial choke fitted thereon as an antenna component to receive wireless programming signals;
an area in the metal or metallized housing which has at least one longitudinal recess;
wherein the at least one recess is located close to the antenna; and
wherein the orientation of the longitudinal recess is designed as essentially parallel to magnetic field lines of the antenna.

10. The control gear of claim 9,
wherein the at least one longitudinal recess has a length of 10 mm to 40 mm and a width of between 1 mm and 3 mm.

11. The control gear of claim 9,
wherein the control gear is configured to be programmed by the ISO 13157/16353 standard.

12. The control gear of claim 9,
wherein the control gear is configured to be programmed by the IEEE 802.15.1 standard.

13. The control gear of claim 9,
wherein a plastic film or plastic wall is located between the recesses and the antenna.

14. The control gear of claim 9,
wherein the choke has an inductance of 2 μH to 6 μH.

15. The control gear of claim 9,
wherein the housing is a punched and curved sheet-metal housing.

16. A wirelessly programmable electronic control gear, comprising:
an essentially enclosed metal or metallized housing made from sheet metal;
a circuit board with an axial choke fitted thereon as an antenna component to receive wireless programming signals;
an area in the metal or metallized housing which has at least one longitudinal recess;
wherein the at least one recess is located close to the antenna;
wherein the at least one longitudinal recess has a width of between 1 mm and 3 mm; and
wherein the orientation of the longitudinal recess is designed as essentially parallel to magnetic field lines of the antenna.

17. The control gear of claim 16,
wherein the at least one longitudinal recess has a length of 10 mm to 40 mm.

18. The control gear of claim 16,
wherein a plastic film or plastic wall is located between the recesses and the antenna.

19. The control gear of claim 16,
wherein the housing is a punched and curved sheet-metal housing.
